(19) United States
(12) Patent Application Publication
(10) Pub. No.: US 2020/0022876 A1
(43) Pub. Date: Jan. 23, 2020

(54) PORTABLE MEDICINE STORING AND DISPENSING APPARATUS AND METHODS

(71) Applicant: TROY G. ANDERSON ENTERPRISES, LLC, Goodyear, AZ (US)

(72) Inventors: Troy G. Anderson, Goodyear, AZ (US); Allan Manna Willie Das, Pune (IN)

(21) Appl. No.: 16/041,702

(22) Filed: Jul. 20, 2018

(51) Int. Cl. A61J 7/04; A61J 1/03

(52) U.S. Cl. CPC A61J 7/0445; A61J 1/03; A61J 7/0454; A61J 7/0084; A61J 7/0436; A61J 2200/30; A61J 7/0481

(57) ABSTRACT

A portable medicine dispensing apparatus includes a housing supporting a dispenser, a controller, and separate medicine storing and dispensing units, each of the units when activated is for automatically depositing a pill of medicine therefrom into the dispenser; and the controller for independently and automatically activating each of the units at pre-determined times.

### FIELD OF THE INVENTION

The present invention relates to prescription medicines and, more particularly, to portable prescription medicine dispensing devices.

### BACKGROUND OF THE INVENTION

A prescription drug is a pharmaceutical preparation that legally requires a medical prescription to be dispensed to a patient. A prescription is a direction, usually written, by a physician to the pharmacist for the preparation and use of a medicine or remedy, which is required for a patient to purchase a prescription drug from a pharmacist. The use of prescription drugs has steadily increased since the 1960s. In the U.S., for example, nearly 90% of older adults 62-85 years of age use at least one prescription drug, while nearly 40% take at least five prescription medicines concurrently.

In the field of prescription drugs, medical adherence or patient compliance mean the adherence of a patient to a prescribed medicine routine, namely, the taking of a prescription drug at the right dose, at the right time, and in the right way and frequency. Non-adherence or patient non-compliance, the failure of a patient to take their medicine as prescribed, can cause chronic disease treatment failure and, in some instances, death. In the United States, the Center for Disease Control and Prevention (CDC) estimates that 20-30 percent of new prescriptions are never filled at a pharmacy, that medicine is not taken as prescribed approximately 50 percent of the time, that after six months the majority of patients prescribed medicines for chronic diseases take less medicine than prescribed or stop taking the medicine altogether, and that only about 50 percent of patients who take medicines for high blood pressure continue taking their medicine during long-term treatment.

There are many reasons that patients fail to take their medicines as prescribed. However, a significant reason for patient non-compliance related to prescription drugs is the inherent difficultly some patients experience managing multiple prescriptions. Accordingly, those having regard for the art will readily appreciate that there is a need for a cost-effective and practicable way for managing multiple prescriptions easily and efficiently and for enabling physicians and health care professionals to track and monitor patient compliance with multiple prescriptions.

### SUMMARY OF THE INVENTION

According to the principle of the invention, a portable medicine dispensing apparatus includes a housing supporting a dispenser, a controller, and separate medicine storing and dispensing units, each of the units when activated is for automatically depositing a pill of medicine therefrom into the dispenser; and the controller for independently and automatically activating each of the units at pre-determined times. A lid is mounted to the housing for movement between a closed position for concurrently enclosing and disabling unauthorized access to the units and to medication deposited therein, and an open position for enabling authorized access to the units. A lock assembly is for locking the lid to the housing when the lid is in the closed position for disabling unauthorized movement of the lid from the closed position to the open position. A signal device is for issuing an alert when activated, and the controller is for activating the signal device proximate to each said predetermined time. The signal device is an aural signal device, and the alert is an audible alert. In another embodiment, the signal device is a visual signal device, and the alert is a visual alert. In yet another embodiment, the signal device is a vibrator, and the alarm comprises a vibratory alert. A sensor is for sensing a withdrawal of at least one pill of medicine from the dispenser; and the signal device automatically deactivates when the sensor senses the withdrawal of at least one pill of medicine from the dispenser. The controller is for issuing a notification to an individual subscriber unit proximate to each said predetermined time, the notification being a reminder to take medication.

According to the principle of the invention, a portable medicine dispensing apparatus includes a housing supporting a dispenser, a controller, and separate medicine storing and dispensing units. Each of the units includes a container including a bottom, a turntable in the container atop the bottom, the turntable mounted for rotation and includes a single pill-receiving aperture, the turntable and the bottom are downwardly inclined concurrently from an upper side of the container to a lower side of the container, the upper side of the container being elevated relative to the lower side of the container, the bottom includes a single discharge opening at the upper side of the container, the container for receiving identically sized and shaped pills of medicine atop the turntable and collecting the pills by gravity at the lower side of the container, the pill-receiving aperture sized and shaped corresponding to the size and the shape of each of the pills of medicine, a motor when activated automatically rotates the turntable from a loading position of the pill-receiving aperture at the lower side of the container to an unloading position of the pill-receiving aperture at the upper side of the container over and registered with the discharge opening, for conveying a pill of medicine received in the pill-receiving aperture at the lower side of the container from the lower side of the container to the discharge opening for enabling the pill of medicine to pass through the discharge opening from the pill-receiving aperture from within the container to the dispenser, and back to the loading position of the pill-receiving aperture at the lower side of the container, and the turntable isolates the container from the discharge opening for disabling pills in the container atop the turntable from passing through the discharge opening from within the container to the dispenser when the turntable is not in the unloading position of the pill-receiving aperture. The controller is for independently and automatically activating each of the motors at pre-determined times. The pill-receiving apertures of the respective units are differently sized and shaped for corresponding the units to differently sized and shaped pills of medicine. A lid is mounted to the housing for movement between a closed position for concurrently enclosing and disabling unauthorized access to the units, and an open position for enabling authorized access to the units. A lock assembly is for locking the lid to the housing when the lid is in the closed position for disabling unauthorized movement of the lid from the closed position to the open position. A signal device is for issuing an alert when activated, and the controller for activating the signal device proximate to each said predetermined time. The signal device is an aural signal device, and the alert is an audible alert. In another embodiment, the signal device is a visual signal device, and the alert is a visual alert. In yet another embodiment, the signal device is a vibrator, and the alarm comprises a vibratory alert. A sensor is for sensing a withdrawal of at least one pill of medicine from the dispenser; and the signal device automatically deactivates when the sensor senses the withdrawal of at least one pill of medicine from the dispenser. The controller is for issuing a notification to an individual subscriber unit proximate to each said predetermined time, the notification being a reminder to take medication.

According to the principle of the invention, a portable medicine dispensing apparatus includes a housing supporting a dispenser, a controller, and separate medicine storing and dispensing units. Each of the units includes a container including a bottom, a turntable in the container atop the bottom, the turntable mounted for rotation and includes a single pill-receiving aperture, the turntable and the bottom are downwardly inclined concurrently from an upper side of the container to a lower side of the container, the upper side of the container being elevated relative to the lower side of the container, the bottom includes a single discharge opening at the upper side of the container to the dispenser, the container pre-filled with a prescription of identically sized and shaped pills of medicine, the pills of medicine being enclosed in the container atop the turntable, and collected by gravity at the lower side of the container, the pill-receiving aperture is sized and shaped corresponding to the size and the shape of each of the pills of medicine, a motor when activated automatically rotates the turntable from a loading position of the pill-receiving aperture at the lower side of the container to an unloading position of the pill-receiving aperture at the upper side of the container over and registered with the discharge opening, for conveying a pill of medicine received in the pill-receiving aperture at the lower side of the container from the lower side of the container to the discharge opening for enabling the pill of medicine to pass through the discharge opening from the pill-receiving aperture from within the container to the dispenser, and back to the loading position of the pill-receiving aperture at the lower side of the container, and the turntable isolates the container from the discharge opening for disabling pills in the container atop the turntable from passing through the discharge opening from within the container to the dispenser when the turntable is not in the unloading position of the pill-receiving aperture. The controller is for independently and automatically activating each of the motors at pre-determined times, the pills of medicine of the respective prescriptions are differently sized and shaped, and the pill-receiving apertures of the respective units are differently sized and shaped corresponding the units to the differently sized and shaped pills of medicine of the respective prescriptions. A lid is mounted to the housing for movement between a closed position for concurrently enclosing and disabling unauthorized access to the units, and an open position for enabling authorized access to the units, the lid is in the closed position, and a lock assembly locks the lid to the housing in the closed position disabling unauthorized movement of the lid from the closed position to the open position. A signal device is for issuing an alert when activated, and the controller for activating the signal device proximate to each said predetermined time. The signal device is an aural signal device, and the alert is an audible alert. In another embodiment, the signal device is a visual signal device, and the alert is a visual alert. In yet another embodiment, the signal device is a vibrator, and the alarm comprises a vibratory alert. A sensor is for sensing a withdrawal of at least one pill of medicine from the dispenser; and the signal device automatically deactivates when the sensor senses the withdrawal of at least one pill of medicine from the dispenser. The controller is for issuing a notification to an individual subscriber unit proximate to each said predetermined time, the notification being a reminder to take medication.

### BRIEF DESCRIPTION OF THE DRAWINGS

Referring to the drawings:

FIG. 1 is a perspective view of a portable medicine dispensing apparatus including a housing having a dispenser, separate medicine storing and dispensing units carried by the housing each including a container enclosed by a cap disabling access to within the various containers and the contents therein, and the units are operatively coupled to the dispenser, wherein each of the units when activated is for automatically depositing a pill of medicine therefrom into the dispenser;

FIG. 2 is a bottom perspective view of the embodiment of FIG. 1;

FIG. 3 is a front elevation view of the embodiment of FIG. 1;

FIG. 4 is a rear elevation view of the embodiment of FIG. 1;

FIG. 5 is a side elevation view of the embodiment of FIG. 1;

FIG. 6 is a top plan view of the embodiment of FIG. 1;

FIG. 7 is a bottom plan view of the embodiment of FIG. 1;

FIG. 8 is a top plan view of one of the units of the embodiment of FIG. 1 with portions thereof being broken away to illustrate the interior thereof;

FIG. 9 is a view similar to that of FIG. 8 illustrating the unit filled with a prescription of pills of medicine;

FIG. 10 is a section view taken along line 10-10 of FIG. 6 showing the unit of FIG. 9 depositing a pill of medicine therefrom into the housing, dotted outline positions of the pill as it would appear dropping by gravity to a chute in the housing operatively coupling the unit to the dispenser, the chute conveying the pill to a receptacle in the dispenser, a dotted line position of the receptacle as it would appear withdrawn from the dispenser, and a dotted line position of the cap as it would appear detached from the container enabling access to within the container;

FIGS. 11-14 are views of the remaining units of the embodiment of FIG. 1 like that of FIG. 8;

FIGS. 15-18 are views of the units corresponding to FIGS. 11-14 showing the respective units each filled with a prescription of pills of medicine.

FIG. 19 is a schematic representation of the embodiment of FIG. 1;

FIG. 20 is a view similar to that of FIG. 1 illustrating the embodiment of FIG. 1 as it would appear configured with a lid, which is closed and locked enclosing the units between the housing and the lid for disabling unauthorized access to the units;

FIG. 21 is a side elevation view of the embodiment of FIG. 20;

FIG. 22 is a view similar to that of FIG. 20 showing the lid unlocked and opened for enabling authorized access to the units;

FIG. 23 is a side elevation view of the embodiment of FIG. 22.

### DETAILED DESCRIPTION

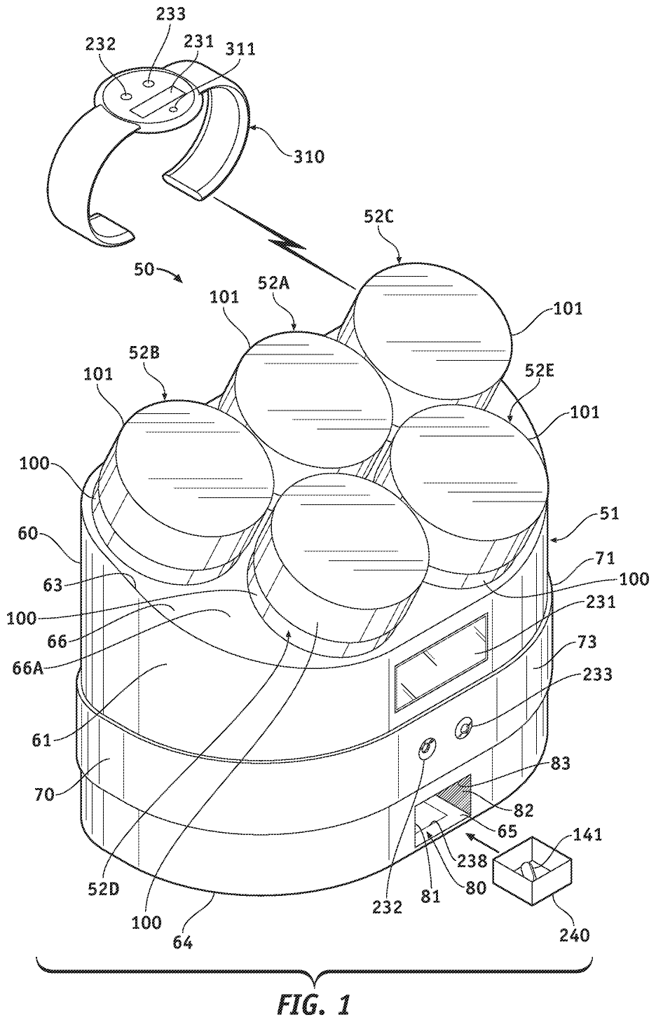

Turning now to the drawings, in which like reference characters indicate corresponding elements throughout the several views, attention is first directed to FIG. 1 illustrating a portable medicine dispensing apparatus 50 including a housing 51 having a dispenser 80, and separate medicine storing and dispensing units 52 carried by housing 51 each including a container shown enclosed by a cap disabling access to within the various containers and the contents therein. Units 52 are operatively coupled to dispenser 80, wherein each of units 52 when activated is for automatically depositing a pill of medicine therefrom into dispenser 80 where it is withdrawn and taken by mouth by a patient authorized to take the medicine via a prescription, a written direction for the preparation and use of a prescription drug. Units 52 are each specifically configured to receive and dispense a particular prescription of identically shaped and sized pills of medicine according to the prescription which, again, is the direction, usually written, by a physician to the pharmacist for the preparation and use of a medicine or remedy being required for a patient to purchase a prescription drug from a pharmacist. Accordingly, apparatus 50 is useful for storing and automatically dispensing a plurality of different prescriptions of pills of medicine for a patient, or for different patients. Apparatus 50 is portable in that it is easily picked up and carried about by hand, enabling the various units 52 to be filled with different prescriptions, programmed, and taken home for use in storing and dispensing the various medicines.

As is known and customary in the art of pills of medicine, for differentiation and identification purposes pills of different medicine conventionally provided in different shapes, standard industry shapes being round, oblong, oval, square, rectangular, diamond, 3-sided, 5-sided, 6-sided, 7-sided, and 8-sided, etc., and in different corresponding sizes. Apparatus 50 is specifically configured to correspond to the inherently different shapes and sizes of pills of medicine of different prescriptions, and to automatically dispense pills of medicine of different prescriptions at the prescribed times and in the prescribed amounts for enabling patients to effortlessly and easily take their medicine according to the prescription directives of the various prescriptions.

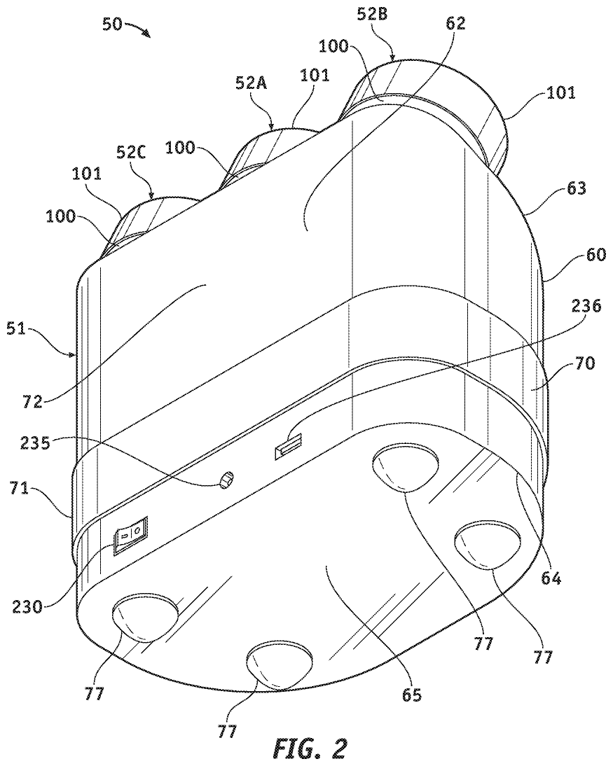

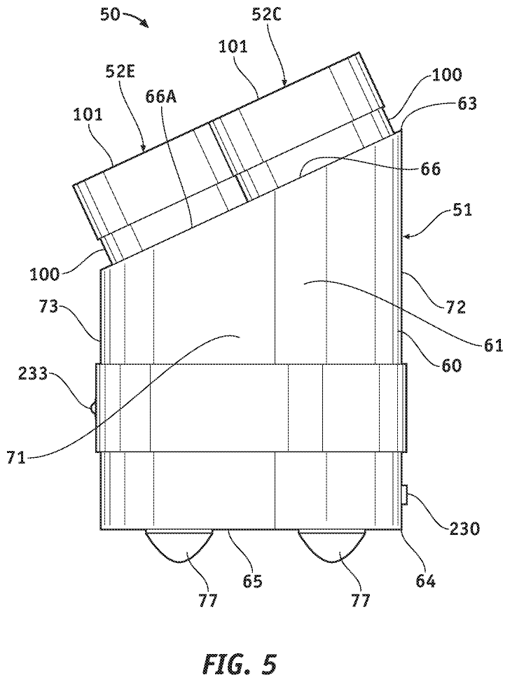

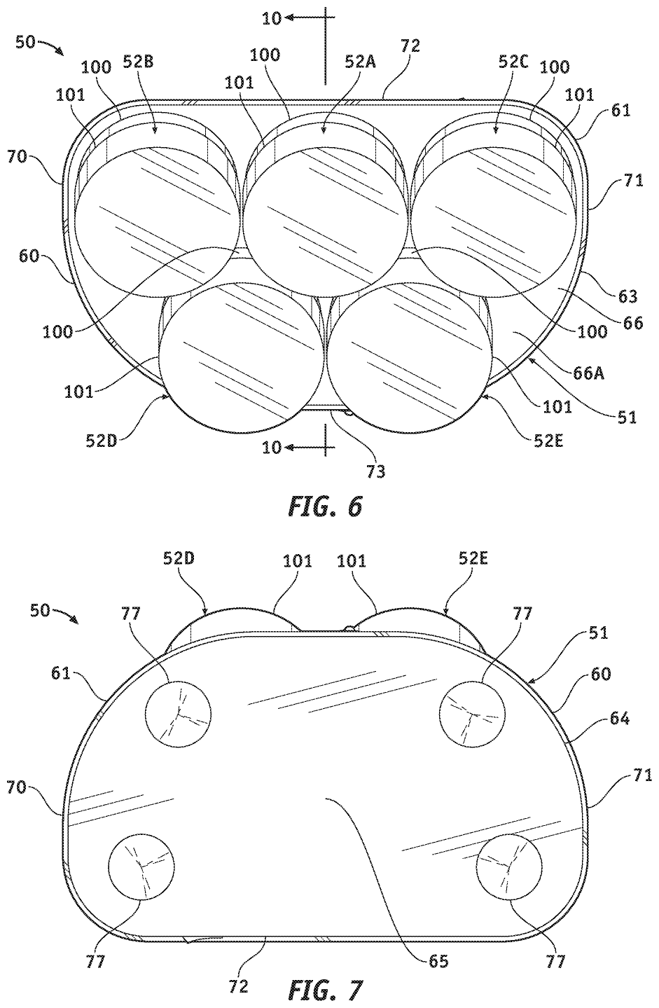

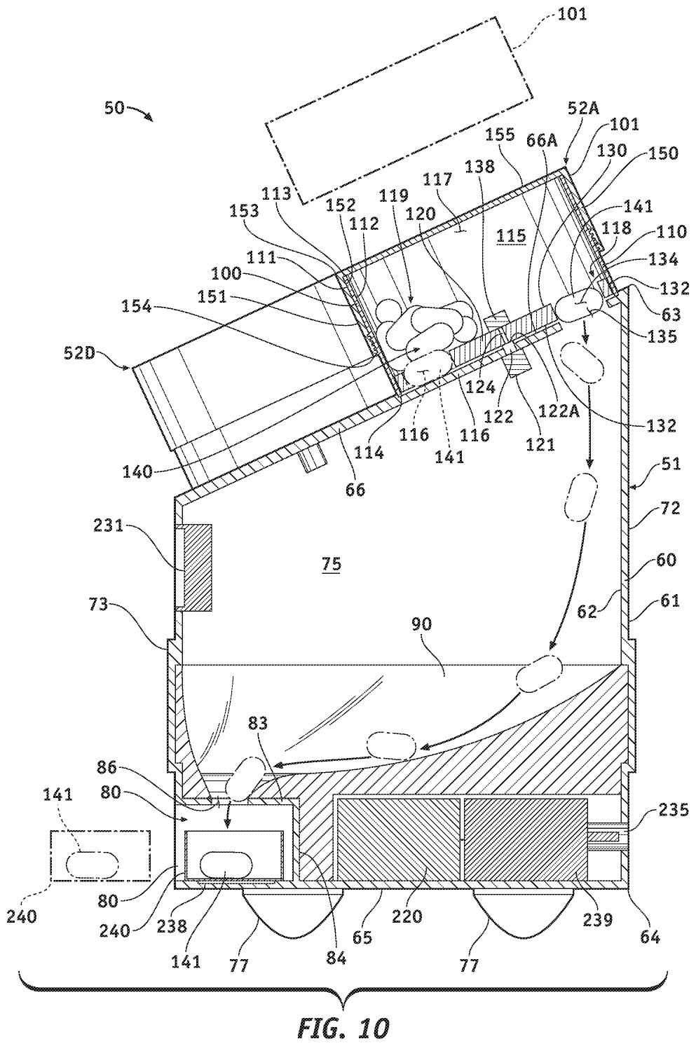

Housing 51 and the containers and the caps of the various units 52 are formed of a material or a combination of materials having the properties of strength, rigidity, resilience, and resistance to heat, such as aluminum, steel, a metal composite, thermosetting plastic, or the like. Housing 51 is fashioned of a plurality of parts joined together with an adhesive, welding, heat bonding, or other joinery according to known assembly techniques. Referencing FIGS. 1-7 and 10 in relevant part, housing 51 is a body that includes continuous sidewall 60 having outer surface 61, inner surface 62, upper edge 63, lower edge 64, horizontal bottom 65 affixed to lower edge 64, and top 66 affixed to upper edge 63. Continuous sidewall 60 extends upright from bottom 65 to top 66, and defines the opposed sides 70 and 71, back 72, and front 73 of housing 51. Top 66 inclines downwardly from back 72 to front 73 at an angle of approximately 20-30 degrees. Bottom 65 at the bottom of housing 51, top 70 at the top of housing 51, and inner surface 62 of continuous sidewall 60 extending upright from bottom 65 to top 66 cooperate to form volume 75 in FIG. 10, which is the contained space or the interior of housing 51 that houses certain components of apparatus 50. In FIGS. 2-5 and 7, a base in the form of supporting feet 77, fashioned of rubber or plastic, are affixed to the outside of bottom 65, and depend downwardly therefrom for supporting apparatus 50 stably upright on a supporting surface, such as a table or a countertop. Four supporting feet 77 are employed in and define the base of apparatus 50 in the present embodiment, and more or less supporting feet 77 can be used without departing from the invention.

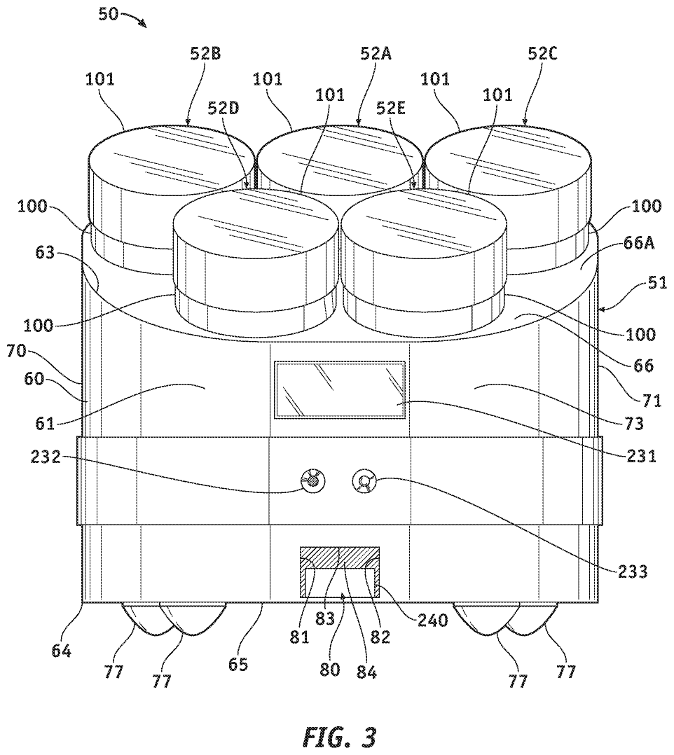

In FIGS. 1, 3, and 10, housing 51 carries dispenser 80. Dispenser 80 is formed in housing 51 at front 73 proximate to bottom 65 at an intermediate position between sides 71 and 72. Dispenser 80 is a horizontal compartment open at front 73 and extends into housing 51 from its opening front 73 as seen in FIG. 10. Referring to FIGS. 3 and 10 in relevant part, dispenser 80 includes opposed, spaced-apart, parallel side walls 81 and 82 that extend upright from bottom 65 to top wall 83 above bottom 65. Side walls 81 and 82, top wall 83, and bottom 65 between sidewalls 81 and 82 and under top wall 83 define the opening to the compartment at front 73, and extend into housing 51 from front 73 to upright back wall 84 in FIG. 10. In FIG. 10, opening 86 in top wall 83 between back wall 84 and front 73 opens to overlying volume 75 of housing 51 and communicates with chute 90 in volume 75 of housing 51. Chute 90 carried by housing 51 is under top 66, inclines downwardly in volume 75 to opening 86 to dispenser 80, and is for receiving and conveying pills of medicine by gravity to dispenser 80 through opening 86. In FIGS. 1 and 2, each of units 52 when activated is for automatically depositing a pill of medicine therefrom into volume 75 of housing 51 in FIG. 1, which falls by gravity to chute 90 which, in response, automatically receives and conveys the pill of medicine by gravity to dispenser 80. Apparatus incorporates five units 52, one of which, unit 52A, will now be discussed in detail.

Referring to FIG. 10, unit 52A includes container 100 and cap 101. Container 100 is a body that includes continuous sidewall 110 having outer surface 111, inner surface 112, upper edge 113, and lower edge 114. Lower edge 114 of continuous sidewall 100 is affixed, such as by welding, heat bonding, adhesive, or other chosen joinery, to upper surface 66A of top 66. The portion of upper surface 66A of top 66 defines bottom 116 of container 100. Accordingly, top 66 forms bottom 116 of container 100, according to the invention, without there being a need for container 100 to have an integrated bottom apart from top 66. Bottom 116 of container 100 cooperates with inner surface 112 of continuous sidewall 110 to form volume 115. Continuous sidewall 100 extends upright from lower edge 114 away from bottom 116 to upper edge 113 that encircles opening 117 to volume 115 that is shown as it would appear closed by cap 101. Cap 101 is movable between a closed position enclosing opening 117 to volume 115 thereby enclosing volume 115 disabling access to within volume 115 and to the contents therein, and an open position, indicated by the dotted line position of cap 101 in FIG. 10, detached from container 100 for opening the opening 117 enabling access to volume 155 within container 110 through opening 117. Container 100 is closed when cap 101 is in its closed position, and is open when cap 101 is in its open position. Continuous sidewall 100 is circular, as are outer and inner surfaces 111 and 112, being a cylindrical barrel, and is perpendicular relative to top 66 and to upper surface 66A of top 66, and is tilted forwardly from back 72 of housing 51 to front 73 of housing 51 at an angle of approximately 20-30 degrees in this example following the same angle of inclination as top 66 from back 72 to front 73. Volume 115 is for receiving contents, a prescription of pills of medicine for a patient, placed therein through opening 117 when container 100 is open. Because container 100 is tilted forwardly from back 72 of housing 51 to front 73 of housing 51, in FIG. 10 container 100 inherently has an upper side denoted at 118 toward back 72 of housing 51 and a lower side denoted at 119 toward front 73 of housing 51, in which upper side 118 of container 100 is elevated relative to lower side 119 of container 100.

A pill-conveyance turntable 120, made of the same material or combination of materials as container 100 and cap 101, is located in volume 115, and is positioned atop upper surface 66A of top 66. A collar 122 of a rotary motor 121 is affixed in an opening 123 through bottom 116 from within container 110 to within housing 51, namely, from volume 115 of container 100 to volume 75 of housing 51. Motor 121 is affixed to collar 122, and depends downwardly from collar 122 from against the undersurface 66B of top 66 of housing 51 that defines bottom 116 of container 100 and into volume 75. Motor 121 is operatively coupled to turntable 120 with a drive shaft 124 coupled between motor 121 and turntable 120. Drive shaft 124 extends through collar 122 from motor 121 to turntable 120, and is rigidly attached to the geometric center of turntable 120 thereby operatively coupling motor 121 to turntable 120, in which rotation of drive shaft 124 by motor 121 imparts corresponding rotation to turntable 120. Motor 121 imparts corresponding rotation turntable 120 via drive shaft 124 rotating turntable 120 in a counterclockwise direction as generally indicated by the arcuate arrowed lines A in FIG. 9, when motor 121 actuates. Accordingly, turntable 120 is mounted in volume 115 of container 100 for rotation, and is driven rotatably by motor 121. Although drive shaft 124 is used to operatively couple motor 121 to turntable 120 for rotating turntable 120 when activated, other power transfer mechanisms can be used, such as a drive gear assembly, a belt drive assembly, etc.

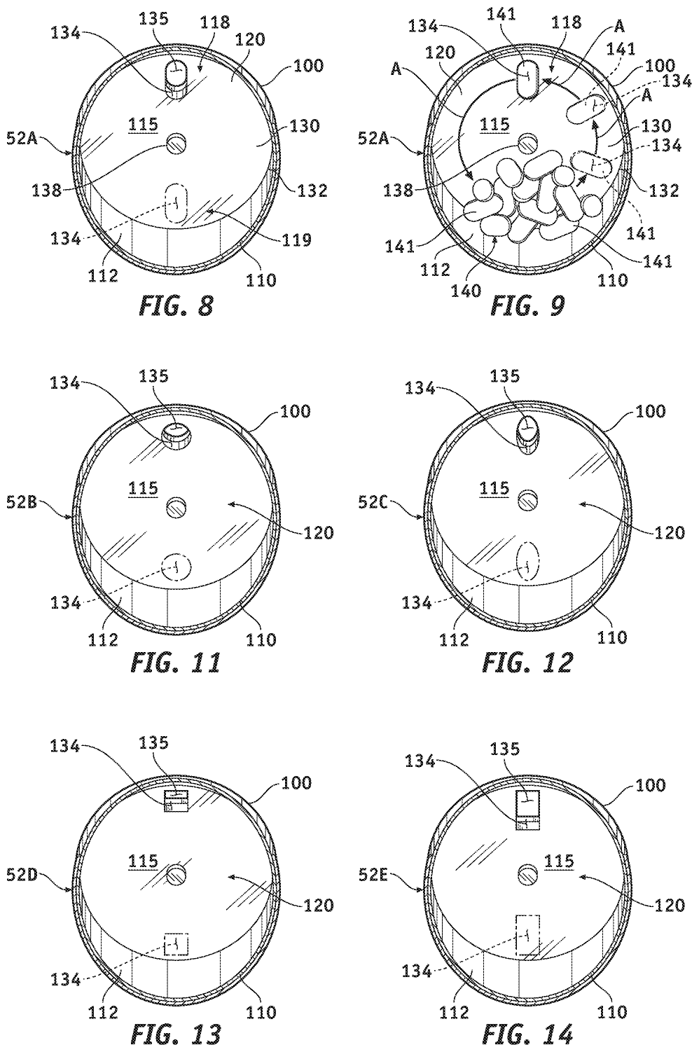

Referring to FIGS. 8, 9, and 10, turntable 120 is a flat, circular disk, which is substantially coextensive relative to bottom 116 of container 100, upper surface 66A of top 66 of housing 51 encircled by inner surface 112 of continuous sidewall 110, and includes opposed upper and lower parallel surfaces 130 and 131 that extend/radiate outwardly concurrently from the geometric center of turntable 120 at drive shaft 124 to perimeter edge 132 proximate to inner surface 112 of continuous sidewall 110. Lower surface 131 is parallel to and faces downwardly toward bottom 116 of container 100, upper surface 66A of top 66 of housing 51, and upper surface 130 faces upwardly into volume 115 of container 100 under opening 117. Collar 122 extends from motor 121 to a distal end 122 in volume 115 just slightly above upper surface 66A. Drive shaft 124 extends through collar 122 from motor 121 and through turntable 120 to a threaded nut 138 that is threaded onto the free end of drive shaft 124 on the outer side of upper surface 130 and which is tightened down via rotation in contact against upper surface 130 capturing turntable 120 between threaded nut 138 and distal end 122A of collar 122 in contact against lower surface 131 of turntable 120.

Turntable 120 has a single pill-receiving aperture 134 formed therethrough, being without a plurality of pill-receiving apertures therethrough. Aperture 134 is adjacent to and slightly inboard of perimeter edge 132 between perimeter edge 132 and the geometric center of turntable 120, and extends through the thickness of turntable 120 from upper surface 130 to lower surface 131. Turntable 120 and bottom 116 of container 100, upper surface 66A of top 66 in this example, are parallel relative to each other and are, therefore, concurrently downwardly inclined concurrently from upper side 118 of container 100 to lower side 119 of container 100. The bottom of container 100 includes a single discharge opening 135 at upper side 118 of container 100 to dispenser 80, namely, to within housing 51 from within container 100, namely, to within volume 75 of housing 51 from within volume 115 of container 100 and, thus, to dispenser 80. Discharge opening 135 extends through bottom 116 of container 100, namely, through top 66 of housing 51 from upper surface 66A of top 66 to lower or undersurface 66B of top 66 facing volume 75. There is only one discharge opening for container 100.

In FIGS. 9 and 10, volume 115 of container 100 is for receiving identically sized and shaped pills 141 of medicine atop upper surface 130 of turntable 130. Pills 141 inherently and automatically collect by gravity at lower side 119 of container 110 resulting from the downwardly inclination of turntable 120 from upper side 118 of container 100 that is elevated relative to lower side 119 of container 100. In other words, pills 141 automatically collect by gravity at lower side 119 of container 100 when pills 141 of medicine are placed in volume 115 atop upper surface 130 of turntable 120 in FIGS. 9 and 10 resulting from the downward inclination of turntable 120 from upper side 118 of container 110 to lower side 119 of container 100. As explained above, turntable 120 is inclined downwardly at an angle of approximately 20-30 degrees, which is sufficient to enable pills placed atop upper surface 130 of turntable to collect by gravity at lower side 119 of container 100. The angle of inclination of turntable 120 can vary as long as it is sufficient to enable pills placed atop upper surface 130 of turntable to collect by gravity at lower side 119 of container 100 when the pills are placed in volume 115 atop upper surface 130 of turntable 120.

Pills 141 are identically shaped, oblong in this example, and sized, and each has an inherent weight. The chosen number of pills 141 constitutes prescription 140 of pills 141 of medicine for a predetermined patient, i.e. an authorized user. Container 100 is specifically configured to relate to the size and shape of each pill 141, in which discharge opening 135 and pill-receiving aperture 134 each has a size and a shape, oblong in this example, which correspond to the size and the shape of each of pills 141 of medicine of prescription 140. Pill-receiving aperture 134 and discharge opening 135 are identically sized and shaped and are just slightly larger in size compared to the size of each of pills 141 for enabling only one pill 141 at a time to be received therein and to pass therethrough. This characterizes how pill-receiving aperture 134 and discharge opening 135 are each sufficiently sized and shaped to correspond to the size and shape of each pill 141, while at the same enabling each pill 141 to pass therethrough, one after the other, according to the invention.

Pill-receiving aperture 134 is movable via the rotation of turntable 120 between a loading position and an unloading position. Pill-receiving aperture 134 is at lower side 119 of container 110, when pill-receiving aperture 134 is in its loading position indicated by the dotted line position of pill-receiving aperture 134 in FIG. 8. In FIG. 9, pill-receiving aperture is at upper side 118 of container 100 and is over and registered with discharge opening 135, when pill-receiving aperture 135 is in its unloading position at upper side 118 of container 100. Since pills 141 inherently collect by gravity at lower side 119 of container 100 when pills 141 of medicine are placed in volume 115 atop upper surface 130 of turntable 120 in FIGS. 9 and 10 resulting from the downward inclination of turntable 120 from upper side 118 of container 110 to lower side 119 of container 100, the collection of pills 141 at lower side 119 of container 100 are inherently herded away and isolated from upper side 118 of container 100 and discharge opening 135 at upper side 118 of container 100 via gravity, according to the invention.

In the operation of unit 52A, turntable 120 is initially set to the loading position of pill-receiving aperture 134 at the dotted line position of pill-receiving aperture 134 in FIG. 8 at lower side 119 of container 100, which inherently positions pill-receiving opening 134 under the population of pills 141 in volume 115 of container 100 collected by gravity at lower side 119 of container 100 and which enables pills 141 to fall by gravity, one at a time, to into and within pill-receiving aperture 134 against upper surface 66A of bottom 116 at lower side 119 of container 100. FIG. 10 shows a dotted line position of pill-receiving aperture 134 in its loading position at lower side 119 of container 100, and a dotted line position of one pill 141 having fallen by gravity to into and within pill-receiving aperture 134 against upper surface 66A of bottom 116 at lower side 119 of container 100. Again, pill-receiving aperture 134 can receive only one pill 141 at a time. Since turntable 120 has only one pill-receiving aperture 134, being without a plurality of pill-receiving apertures, turntable 120 is specifically configured to convey one pill 141 at a time when turntable 120 rotates, according to the invention. Motor 121 in FIG. 10 when activated automatically rotates turntable 120, in a counterclockwise direction in this example, in FIG. 9 from the loading position of pill-receiving aperture 134 at lower side 119 of container 100, shown by the dotted line position of pill-receiving aperture 134 in FIGS. 8 and 10, to the unloading position of pill-receiving aperture 134 at upper side 118 of container 100 in FIG. 9 over and registered with discharge opening 135, for conveying one pill 141 of medicine received in pill-receiving aperture 134 against upper surface 66A at lower side 119 of container 100 in FIG. 10 across upper surface 66A from lower side 119 of container 100 to discharge opening 135 at upper side 118 of container 100, and back to the loading position of pill-receiving aperture 134 at lower side 119 of container 100. When pill-receiving aperture 134 is in its unloading position, pill-receiving aperture 134 and the one pill 141 in pill-receiving aperture 134 are concurrently registered with discharge opening 135, which is sufficiently sized and shaped to enable pill 141 to pass/fall therethrough by gravity, enables pill 141 to automatically pass/fall by gravity through discharge opening 135 from pill-receiving aperture 134 from within container 100 to chute 90 in housing 51. When chute 90 receives the falling pill 141 it falls by gravity along chute 90, which automatically funnels the pill 141 downwardly therealong by gravity to opening 86 through which the pill 141 falls by gravity into dispenser 80. When motor 121 activates, it automatically rotates turntable 120 one rotation from the loading position of pill-receiving aperture 134 for discharging one pill 141, a dosage, to dispenser 80. Pill-receiving aperture 134 and discharge opening 135 are misaligned, when turntable 120 is not in the unloading position of pill-receiving aperture 134. According to the invention, turntable 120 isolates volume 115 of container 100 from discharge opening 135 for disabling pills 141 in volume 115 of container 100 atop upper surface 130 of turntable 120 from falling through discharge opening 135 from within volume 115 of container 100 to within volume 75 of housing 51 when turntable 120 is not in the unloading position of pill-receiving aperture 134 inherently misaligning pill-receiving aperture 134 and discharge opening 135. The gravity collection of pills 141 atop upper surface 130 of turntable 120 at lower side 119 of container 100 also isolates them from upper side 118 of container 100.

In FIG. 10, cap 101 is a body that includes continuous sidewall 150 having outer surface 151, inner surface 152, upper edge 153, lower edge 154. Horizontal top 155 is affixed to upper edge 153. Lower edge 114 of continuous sidewall 100 is affixed to upper surface 66A of top 66, which defines bottom 116 of container 100. Continuous sidewall 150 of cap 101 is inwardly threaded, in which inner surface 152 is threaded, and continuous sidewall 119 of container 100 is outwardly threaded, in which outer surface 111 is outwardly threaded. In the closed position of cap 101 in FIG. 10, cap 101 is received over opening 117 and over continuous sidewall 110, and by rotating cap 101 in a clockwise direction the inwardly threaded continuous sidewall 150 of cap 101 threads onto the outwardly threaded continuous sidewall 110 of container 100 and cap 101 is tightened down via rotation until top 155 comes into direct contact against upper edge 113 of container 100 thereby closing opening 117 to and enclosing volume 155 disabling access to within volume 115 of container 100 and to the contents therein. Reversing this operation enables cap 101 to be released from container 100 from its closed position to its open position depicted by the dotted line position of cap 101 in FIG. 10 to enable access into volume 115 and to the contents therein through opening 117. The inwardly threaded and outwardly threaded parts of cap 101 and container 100, respectively, enable cap 101 to be selectively secured to and released from container 100. In an alternate embodiment, cap 101 is a conventional safety cap when required by regulation for prescription drugs.

With the exception of the size and shape of the pill-receiving aperture 134 and the discharge opening 135, units 52B-52E are identical in every respect to unit 52A and function identically to unit 52A, and the foregoing discussion of unit 52 applies in every respect to units 52B-52E and the same reference characters of unit 52A are also used with units 52B-52B as needed throughout the balance of this disclosure. Units 52 are specifically configured to receive and dispense different respective prescriptions of different identically sized and shaped pills of medicine. As described above, unit 52A is for receiving and dispensing identically shaped and sized pills 141 of prescription 140, in which pill-receiving aperture 134, discharge opening 135, and each pill 141 of prescription 140 of unit 52A are oblong and sized correspondingly. The remaining units 52B-52E will now be discussed briefly in conjunction with their separate prescriptions.

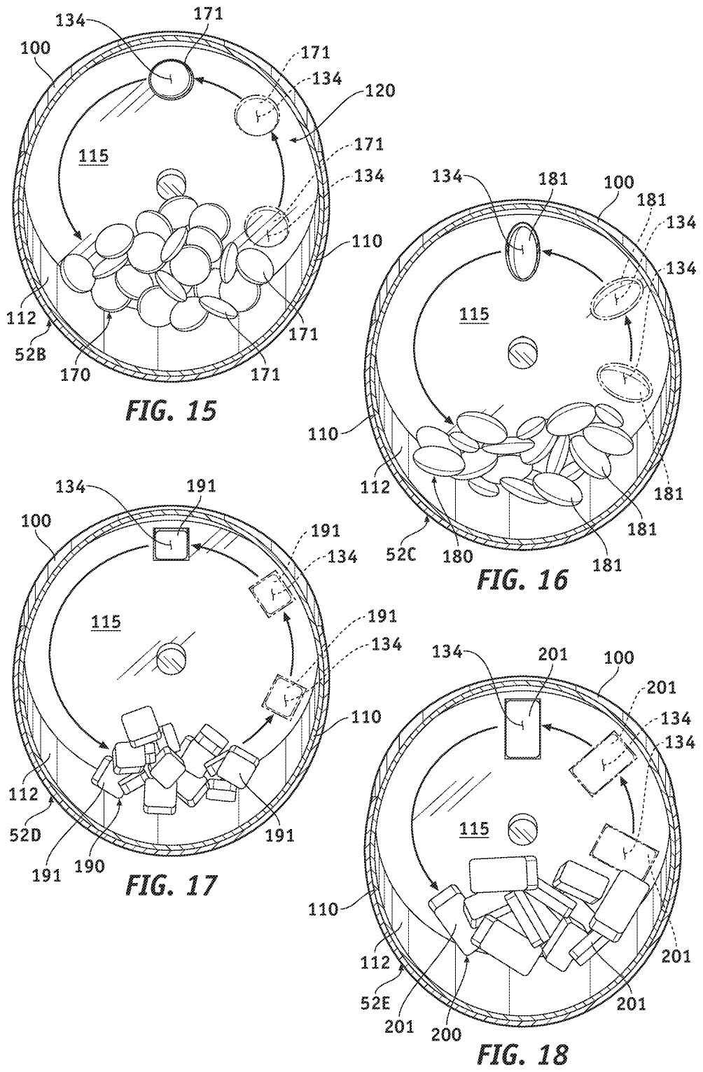

FIGS. 11-14 are views of remaining units 52B-52E, respectively, like that of unit 52A in FIG. 8, and FIGS. 15-18 are views of units 52B-52E, respectively, like that of unit 52A in FIG. 9, showing the respective units 52B-52E each filled with a prescription of pills of medicine. In FIGS. 11 and 15, unit 52B is for receiving and dispensing identically shaped and sized pills 171 of prescription 170 (FIG. 15), in which pill-receiving aperture 134, discharge opening 135, and each pill 171 of prescription 170 of unit 52B are round in shape and sized correspondingly. In FIGS. 12 and 16, unit 52C is for receiving and dispensing identically shaped and sized pills 181 of prescription 180 (FIG. 16), in which pill-receiving aperture 134, discharge opening 135, and each pill 181 of prescription 180 of unit 52C are oval in shape and sized correspondingly. In FIGS. 13 and 17, unit 52D is for receiving and dispensing identically shaped and sized pills 191 of prescription 190 (FIG. 17), in which pill-receiving aperture 134, discharge opening 135, and each pill 191 of prescription 190 of unit 52D are square in shape and sized correspondingly. In FIGS. 14 and 18, unit 52E is for receiving and dispensing identically shaped and sized pills 201 of prescription 200 (FIG. 18), in which pill-receiving aperture 134, discharge opening 135, and each pill 201 of prescription 200 of unit 52E are rectangular in shape and sized correspondingly. Each of pills 171, pills 181, pills 191, and pills 201 has an inherent weight. The examples of the shapes and sizes of the pills of the various prescriptions and corresponding pill-receiving apertures 134 and discharge openings 135 of the various units 52A-52E are chosen by way of example, and other shapes and sizes can be used depending on the shapes and sizes of the pills of prescription medicine employed with apparatus 50. The electronic components and associated features of apparatus 50 will now be discussed.

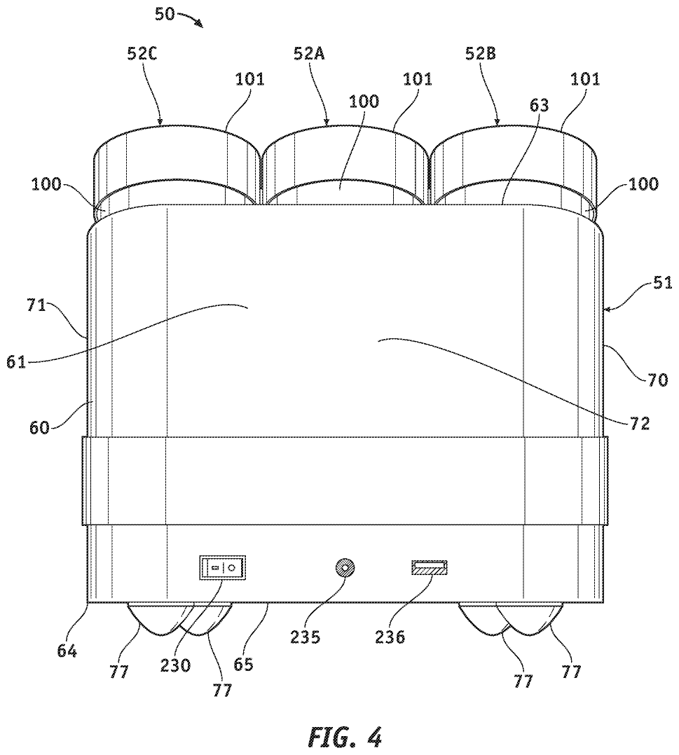

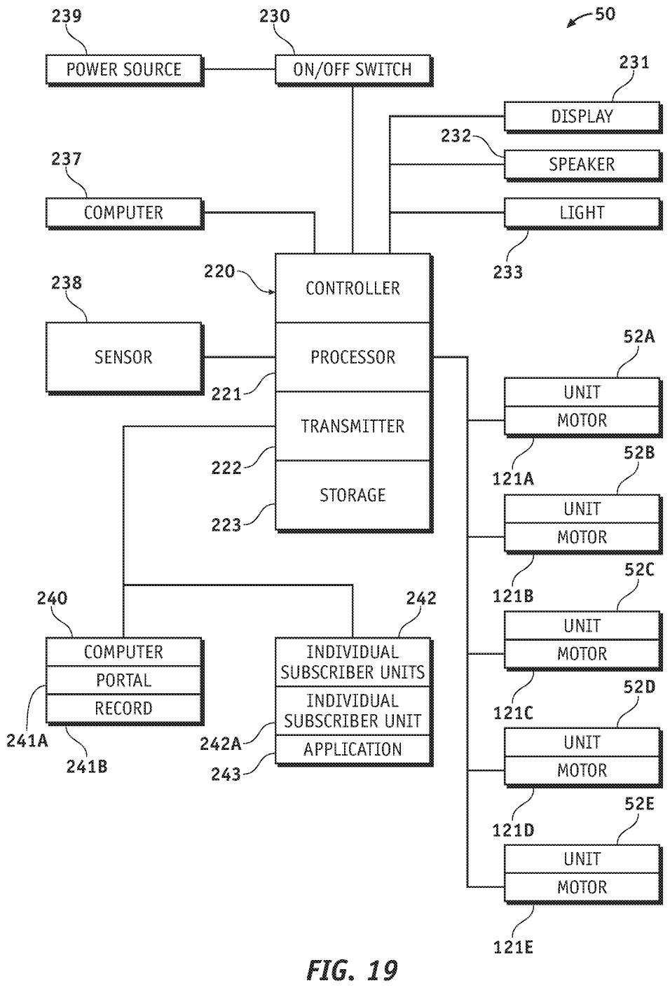

In FIGS. 10 and 19, apparatus 50 is configured with controller 220 including processor 221, transmitter/receiver 222, and storage 223 in FIG. 19, ON/OFF switch 230 in FIGS. 2, 4, and 19, signal devices including electronic display 231 in FIGS. 1, 3, 10, and 19, speaker 232, and light 234 in FIGS. 1, 3, and 19, plug 235 and data port 236 in FIGS. 2 and 4, sensor 238 in FIGS. 10 and 19, and power source 239, which are operatively and electrically connected via conventional electrical circuitry/wiring well known to the skilled electrician. Controller 220 is housed in and is carried by housing 51 in FIG. 10 atop bottom 65 under chute 90, ON/OFF switch 230, plug 235, and data port 236 are formed in back 72 of housing 51 near bottom 65 between sides 71 and 72 of housing 51 in FIGS. 2 and 4, and electronic display 231, speaker 232, and light 234 are formed in front 73 of housing 51 between top 66 and dispenser 80 between sides 71 and 72 of housing in FIGS. 1 and 3. In FIG. 10, sensor 238, a conventional load cell, is formed in bottom 66 of dispenser 80. Power source 230 is an onboard and conventional rechargeable battery pack, which is in housing 51 near controller 220 atop bottom 65 under chute 90, and which is electrically connected to plug 235 at back 72 of housing 51.

In FIG. 19 processor 221 is electrically and operatively connected to each motor 121 of each of units 52A-52E for independently and automatically activating each of motors 121 of units 52A-52E at pre-determined times, which can be the same times or different times. Sensor 238 is electrically connected to processor 221, which operatively connects sensor 238 to the motors 121 of each of units 52A-52E, display 231, speaker 232, and light 233. Controller 220 is electrically connected to power source 239 that provides electrical power to all controller 220 components, display 231, speaker 232, light 233, sensor 238, and to the motors 121 of the respective units 52A-52E.

Display 231, speaker 232, and light 233 are signal devices, which are each configured to issue alerts/signals each for notifying/alerting a patient when it is time to take a dosage of medicine dispensed to dispenser 80, according to the invention. Display 231 is a visual signal device which when activated emits visual signals being text/written messages that are capable of being seen and read. Display 231 is a conventional electronic display commonly found in home thermostats and the like and any suitable and well known electronic display can be used. Speaker 232 is a conventional aural device commonly found in cellular phones and the like that when activated emits audible stimuli, signals, or alarms capable of being heard. Light 233 is, like display 231, a type of visual signal device in the nature of a conventional light source operative to emit illumination when activated in the nature of visual signals, stimuli, or alarms capable of being seen, such as a constant illumination or flashing illumination. Light 233 is preferably at least one light-emitting diode (LED). Processor 221 is a conventional and well-known processor, and storage 223 is conventional electronic storage. Processor 221 is programmed with instructions stored in storage 223 which when executed by processor 221 cause processor 221 to perform the functions of controller 220 disclosed herein and to, according to the invention, record the operations of apparatus 50 in storage 223, which can be transmitted electronically via transmitter/receiver 22 from storage 223 to a remote computer in communication with controller 220 for storage into a patient's electronic medical record. The operations of apparatus 50 recorded in storage 233 document/record the patient's compliance or non-compliance in taking the medication of a prescription of apparatus 50, according to the invention. Controller 220 is programmed via the programming of processor 221, and operates according to the instructions/programming in storage 223 executed by processor 221. Data port 236 is conventional and can be connected to computer 237 (FIG. 19) via a conventional data cord for programming controller 220 storage 223.

ON/OFF switch 100, controller 220, display 231, speaker 232, light 233, sensor 238, and motors 121A-121E are electrically connected with conventional electronic circuitry/wiring. The conventional circuitry/wiring incorporated in apparatus 50 operatively couples processor 221 to transmitter/receiver 222 and storage 223, power source 239, sensor 238, display 231, speaker 232, light 233, and motor 121 of each of units 52A-52E. ON/OFF switch 230 is the main ON/OFF switch of apparatus 50, and is a conventional and readily available toggle switch movable between an ON position powering and activating controller 220, motors 121A-121E, display 231, speaker 232, light 233, and sensor 238, and an OFF position deactivating the described electrical components of apparatus 50. In the discussion of the operation of apparatus 50, ON/OFF switch 230 is enabled in the ON position.

The electrical components of apparatus 50 described herein operate in a DC-powered environment, and power source 239 is an onboard DC power source consisting of one or more conventional rechargeable batteries which can be periodically recharged by connecting plug 235 to a dedicated power source via a power cord. The conventional electric circuitry/wiring enables apparatus 50 to run off the power of a dedicated power source when plug 235 is electrically connected to a dedicated power source via a power cord, while at the same time enabling the recharging of the apparatus 50 onboard power source 239. Those having ordinary skill in the art will readily appreciate that any suitable form of battery power source, including any desired or suitable number of batteries, including one or more rechargeable batteries, may be provided and utilized for the power source onboard apparatus 50. If desired, apparatus 50 can be furnished with a power indicator light that illuminates in the ON position of switch 230 to provide a visual indication that control apparatus 50 is activated or otherwise powered up, and that deactivates in the OFF position of switch 230 to provide a visual indication that apparatus 50 is deactivated or otherwise powered down.

Processor 221 is preprogrammed with instructions maintained in storage 223 that when executed by processor 221 enables controller 220 to operate units 52A-52E, display 231, speaker 232, light 233, and to function in concert sensor 238 operatively connected to processor 221 according to the following discussion of the apparatus 50 functions. The operation of units 52A-52B by the controller 220 processor 221 is identical. Accordingly, the operation of unit 52A by the controller 220 will now be discussed, with the understanding that the ensuing discussion of unit 52A applies equally to each of the remaining units 52B-52E.

In the operation of unit 52A, container 100 is opened, charged/filled with prescription 140 of a predetermined number of pills 141 of medicine in FIG. 9, closed with cap 101, and storage 223 of controller 220 is programmed with prescription instructions which are executed by processor 221 to independently and automatically activate motor 121 of unit 52A at pre-determined times for dispensing pills 141 in the predetermined amounts/dosages, being one-at-a-time, at the pre-determined times directed by the prescription instructions maintained by storage 223, according to the principle of the invention. Charging container 100 with pills 141 is carried out by a skilled practitioner, such as a pharmacist, doctor, or authorized caregiver, who is authorized to dispense prescription 140 according to the corresponding prescription. Programming storage 223 with the associated prescription instructions can be done by a skilled practitioner, such as a pharmacist, doctor, or authorized caregiver, who is authorized to prescribe and/or dispense prescription 140 according to the corresponding prescription. In a particular embodiment, the prescription is entered into an electronic medical record system or computer and transmitted therefrom electronically to controller 220 in communication with the medical record system or computer for storage in storage 223, according to the invention.

To program storage 223 in one embodiment, apparatus 50 is turned ON by moving switch 239 from its OFF position to its ON position, data port 236 is connected to a computer 237 in FIG. 19 via a data cord for operatively connecting the computer 237 to controller 220, and computer 237 is used to electronically transmit the prescription instructions to storage 223, after which the data cord is detached from data port 236 and apparatus 50 is turned OFF by moving switch 239 from its ON position to its OFF position.

In the alternative according to a preferred embodiment, storage 223 is programmed remotely. In this example, apparatus 50 is network-enabled and cellular-enabled via transmitter/receiver 222, which is a conventional transmitter/receiver that enables apparatus 50 to conventionally connect in communication to a networked device, such as an electronic medical record system or computer 240 in FIGS. 1 and 19 over a computer network, such as an Internet, a local area network, a wireless computer network, or other computer network, and to conventionally connect in communication to one or more cellular devices via a wireless telephonic/cellular network, all for enabling the electronic transmission of data to storage 223 for programming controller 220 with prescription instructions, according to the invention. Preferably, each prescription for apparatus 50 is entered into electronic medical record system or computer 240, and transmitted electronically therefrom to storage 223. Controller 220 is, therefore, preferably programmed remotely via computer 240, which can be a local computer, a cloud computer, such as a cloud server, or the like. Computer 240 incorporates conventional storage and hardware and software elements for proper and intended operation and data storage or maintenance, and is coupled to send and receive data/information to and from controller 220 of apparatus 50 in a conventional and well known manner over a computer network.

In use, apparatus 50 is turned ON by moving switch 239 from its OFF position to its ON position and a small cup 249 is placed into dispenser 80 atop sensor 238 in FIG. 10. Cup 249 forms a part of dispenser 80 when cup is placed in dispenser 80 atop sensor 238. At a predetermined time when a dosage from prescription 140 is to be dispensed, processor 221 of controller 220, programmed with and acting on the preprogrammed prescription instructions maintained by storage 223, is responsive and automatically activates motor 121. When motor 121 activates, it automatically rotates turntable 120 from the loading position of pill-receiving aperture 134 in FIGS. 8 and 10 at lower side 119 of container 100 to the unloading position of pill-receiving aperture 134 in FIGS. 9 and 10 at upper side 118 of container 100 over and registered with discharge opening 135 thereby conveying one pill 141, having fallen into pill-receiving aperture 134 by gravity onto upper surface 66A of bottom 116 at lower side 119 of container 100 in FIG. 10, from lower side 119 of container 100 to discharge opening 135 at upper side 118 of container 100, and back to the unloading position of pill-receiving aperture 134 at lower side 119 of container 100 enabling another one of pills 141 to fall by gravity into pill-receiving aperture 141 against upper surface 66A of bottom 116 in response in preparation for being conveyed to discharge opening 135 the next time motor 121 activates. When pill-receiving opening 134 and the pill 141 therein reach the unloading position of pill-receiving aperture 134 registering the pill 141 therein with discharge opening 135, the pill 141 automatically passes by gravity through discharge opening 135 from pill-receiving aperture 134 from within container 100 to chute 90 in volume 75 of housing 51. When chute 90 receives the falling pill 141 it falls by gravity along chute 90, which automatically funnels the pill 41 downwardly therealong by gravity to opening 86, through which the pill 141 falls by gravity into dispenser 80 and into cup 249 in dispenser 80 atop sensor 238.

When the pill 141 deposits into cup 249, sensor 238, which is a conventional load cell, automatically senses the arrival of pill 141 when it senses the inherent weight of pill 141 and, in response, automatically generates a first signal, an “arrival” signal, that is received by processor 221 via the operative coupling between sensor 238 to processor 221. In response to receiving this first/arrival signal from sensor 238, i.e. in response to sensor 238 sensing the arrival of pill 141 in dispenser 80, processor 221 is responsive and automatically deactivates motor 121, and at the same time automatically transmits a signal, a “dispensed” signal. The signal devices operatively coupled to controller 220 automatically activate in response to the dispensed signal to notify or otherwise alert a patient, via the respective notifications/alarms/alerts, prescribed the medicine of prescription 140 that a dosage in the form of pill 141 is in dispenser 80 and that it is time to take the pill 141 in cup 249 in dispenser 80, according to the invention. When processor 221 deactivates motor 121, motor 121 continuous to rotate until pill-receiving aperture 134 reaches its starting loading position at lower side 119 of container 120. The rate of rotation of turntable 120 by motor 121 is chosen to be sufficiently slow to enable a pill that falls into housing 51 from discharge opening 135 to fall by gravity into dispenser 80 before turntable 120 rotates pill-receiving opening 135 back to its starting loading position. Furthermore, motor 121 will continue to rotate turntable 120 until a pill is dispensed to dispenser 80 and sensor 238 senses the arrival of a pill by dispenser 80.

In response to activation of display 231 by processor 221, display 231, a visual signal device, issues its notification, a visual alarm/alert being a “medication dispensed message,” a text message preprogrammed in storage 223 that is capable of being seen and read, such as “TIME TO TAKE YOUR MEDICINE,” “PLEASE TAKE YOUR MEDICINE,” or other similar message intended to communicate that it is time to take a dosage of medicine, according to the invention. In response to activation of speaker 232 by processor 221, speaker 221, an aural signal device, issues its notification, an audible alarm/alert providing to the patient an audible signal or alarm alerting him that it is time to take his medicine. The audible alarm/alert is preferably a shrill, easily heard noise, serious of noises, or pattern of noises, and may also be a pre-recorded verbal message programmed in storage 223, such as “TIME TO TAKE YOUR MEDICINE,” “PLEASE TAKE YOUR MEDICINE,” or the like, designed to communicate that it is time for the patient to take his medicine. Each such message for unit 52A and prescription 140 therein can include additional information identifying the patient prescribed the given medication, such as the name of the patent, i.e. “JOHN SMITH,” “EDWARD GIBBS,” “JANE CAMPBELL,” to prevent confusion and to ensure the patient knows the medication is for him/her. In response to activation of light 233 by processor 221, light 233, a visual signal device, illuminates to issue its notification being an illumination capable of being seen providing to a patient a visual notification/signal of the time to take his medicine. The illumination issued by light 233, a visual notification/alarm/alert, is bright and intended to be easily seen, and can be a blinking/flashing illumination, or a constant illumination as may be desired. In response to the alarms/alerts issued by the various signal devices, display 231, speaker 232, and light 233, the patient being alerted to the time to take his medicine will reach into dispenser 80 by hand and grab and withdraw cup 249, and pill 141 contained therein, outwardly from dispenser 80, as indicated by the dotted line position of cup 249 in FIG. 10 to take the pill 141 by mouth from cup 249, such as with water or other beverage as is customary when taking a pill by mouth. When cup 249 and pill 141 therein is withdrawn from dispenser 80, the inherent weight of pill 141 is withdrawn from sensor 239 which, in response, which senses the withdrawal of pill 141 and automatically generates a second signal, a “withdrawal” signal, in response, that is received by processor 221 via the operative coupling between sensor 238 and processor 221. In response to receiving this second or withdrawal signal from sensor 238, sensor 238 sensing the withdrawal of pill 141 from dispenser 80, processor 221 is responsive and automatically transmits another signal, a “withdraw” signal. The signal devices operatively coupled to controller 220 automatically deactivate, stopping the corresponding alerts, in response to the withdraw signal. This process is automatically repeated at each predetermined time to take a type of medicine, namely, each time when a dosage of medicine from prescription 140 arrives.

Processor 221 of controller 220 can be programmed with instructions maintained by storage 223 to activate and correspondingly deactivate one of the signal devices, two of the signal devices, or, as explained above, each of the signal devices depending on particular preferences. Furthermore, although apparatus 50 incorporates two visual signal devices, display 231 and light 233, and one aural signal device, speaker 232, apparatus 50 can be configured with just one of the signal devices or two of the three signal devices as may be desired. In an alternate embodiment, controller 220 is programmed via instructions/programming in storage 223 that when executed by processor 221 causes processor to activate one or more of the above-described signal devices proximate to each described predetermined time instead of being activated in response to sensor 238 sensing the arrival of medication, i.e. at least one pill, in dispenser 80. In this embodiment, controller 220 operates as before and deactivates one or more of the signal devices in response to sensor 238 sensing the withdrawal of medication, i.e. at least one pill, from dispenser 80.

Processor 221 of controller 220 can be programmed with instructions maintained by storage 223 to activate and correspondingly deactivate one of the signal devices, two of the signal devices, or, as explained above, each of the signal devices depending on particular preferences. Furthermore, although apparatus 50 incorporates two visual signal devices, display 231 and light 233, and one aural signal device, speaker 232, apparatus 50 can be configured with just one of the signal devices or two of the three signal devices as may be desired. Again, all the operations of apparatus 50 in connection with the dispensing of medication of prescription 140 are recorded in storage 233 and document/record the patient's compliance or non-compliance in taking the medication of prescription 140 of apparatus 50, according to the invention.

According to the invention, apparatus 50 is useful with individual subscriber units 242. Individual subscriber units 242 each consist of a wireless communications device capable of communicating through wireless networks, such as a wireless computer network or Internet, and a wireless telephonic network or cellular network. Individual subscriber units 240 may each include, for instance, a cellular phone or other cellular device, a personal digital assistant, a pager, a computer, a laptop computer, or other form of conventional or readily-available wireless communications device structured to communicate through a wireless computer network and also a wireless telephonic network. Each individual subscriber units 240 is conventionally assigned an address that is used by others to communicate with that individual subscriber unit, such as a telephone number used by others to issue calls to that individual subscriber unit, such as voice calls, text message calls or simply text messages, or an email address used by others to issue emails to that individual subscriber unit 242.

According to the invention, at each predetermined time to take a given dosage of medication, when processor 221 of controller 220 automatically transmits the “dispensed” signal as described above proximate to each predetermined time to take the given dosage of medication, controller 220 is response and automatically issues a message, a corresponding “dispensed” notification/alarm/alert, via transmitter/receiver 222 to individual subscriber unit 242A assigned to the patient. The issued message is the “medication dispensed message” stored in storage 223, as previously described being a reminder or notification to take medication dispensed to dispenser 80. Accordingly, the medication dispensed message from storage 223 is for notifying/alerting the intended recipient, the patient prescribed the medicine of prescription 140, that a dosage of medication in the form of pill 141 in this example is in dispenser 80 and that it is time to take the pill 141 in cup 249 in dispenser 80. The message to individual subscriber unit is an email in one embodiment, and is a text message in another embodiment. Providing notifications/alerts via individual subscriber unit 242A provide an additional level of notification for the patient.

In this embodiment of the invention, storage 223 is preprogrammed with one or more email addresses and one or more cellular phone numbers for sending emails and/or text messages and/or audio files not only to individual subscriber unit 242A of the patient but also individual subscriber units 242 of other chosen recipients, such as the patient's doctor, caregiver, spouse, significant other, etc., for enabling each of these other chosen recipients to, along with the patient, to receive the corresponding notifications and to follow up with the patient to ensure he is taking his medication in compliance with the prescription. Accordingly, apparatus 50 can be associated with multiple individual subscriber units 242 each assigned to different recipients, including the patient, the patient's doctor, pharmacist, caregiver, spouse, etc.

Each individual subscriber unit 242 is preferably configured with application 243, an application designed for an individual subscriber unit, designed to receive the medication dispensed messages in the form of conventional push notifications to alert the intended recipient of the time to take the medication via application 243. In addition to providing an alert or notification of the time to take a dosage of medication, each message can contain additional information unique to the given prescription and/or the patient, including a patient file reference, the name and contact information for the patient, information for the prescribing doctor, the pharmacy from which the medication was dispensed, etc., and/or other chosen information. According to the invention, each individual subscriber unit 242 is a form of a signal device operatively coupled to controller 220 for issuing an alert, i.e. a received text message from controller 220, a received email message from controller 220, and/a received application 243 push notification from controller 220.

Transmitter/receiver 221 enables remote communication between controller 220 and networked appliances, such as computer 240, for enabling the electronic transmission of instructions to storage 223 from computer 240 for unit 52A, for remotely controlling apparatus 50 from computer 240 or other networked device for controlling the operation of unit 52A, and for electronically transmitting data from storage 223 into electronic data file or record 241B at computer 240 for prescription 140 of unit 52A. Computer 240 maintains record 241B that is unique to prescription 140 of unit 52A and to the patient prescribed prescription 140. Record 241B is configured with the prescription information for prescription 140, the patient prescribed prescription 140, the patient's prescribing doctor, the patient's pharmacy, and the operations of apparatus 50 in conjunction with unit 52A. Record 241B is an electronic medical record related to prescription 140 and the dispensing of prescription via apparatus 50 documenting the patient's compliance or non-compliance related to taking the medication of prescription 140.

Processor 221 of controller 220 is automatically programmed, whether by processor 221 accessing computer 240 or computer 240 accessing processor 221. In one embodiment, computer 240 is configured to automatically initiate communication with controller 220 at predetermined times for transmitting prescription information to controller 220. In another embodiment, processor 221 of controller 220 is configured to automatically request/fetch prescription information from computer 240, by periodically pooling computer 240 for updates, such as once in every few days, hours, minutes, or seconds. Processor 221 of controller 220 is also configured to automatically electronically transmit information of the operation of apparatus 50 in conjunction with the operation of unit 52A with prescription 140 to computer 240 for storage in corresponding data file or record 241B in FIG. 19, in which the information/data in record 241B is compiled and ordered documenting apparatus 50 functions in conjunction with unit 52A in conjunction with prescription 140, documenting the patient's compliance or non-compliance in taking the medication of a prescription of apparatus 50 in record 241B, for inclusion in the patient's medical records. Any authorized party, such as a pharmacist, doctor, or caregiver, can access selected patient prescription and schedule information for apparatus 50 via computer 240 and evaluate, review, and/or update the prescription and schedule for being electronically transferred apparatus 50.

When the prescription schedule/information at computer 240 changes or is updated, computer 240 can be configured to automatically connect to processor 221 of controller 220 and automatically electronically transmit the updated information via automatic updating enabling controller 220 to operate apparatus 50 accordingly. Furthermore, if instructions entered into computer 240 call for discontinuing medicine dispensing, such as if the information of the operation of apparatus 50 recorded in storage 233 indicates a patient's non-compliance in taking the medication of a prescription of apparatus 50, controller 220 will automatically deactivate medicine dispensing from unit 52A in response when the information is downloaded to processor 221 from computer 240. Any prescription-dispensing instructions uploaded into processor 221 is executed by processor 221 automatically and immediately in response to cause controller 220 to automatically operate apparatus 50 in conjunction with unit 52A and the prescription thereof accordingly.

Preferably, electronic access to record 241B is made via portal 241A, a gateway, at computer 240 to record 241B, via a chosen login procedure to enable record 241B information for unit 52A and its corresponding prescription to be accessed, to program apparatus 50 with prescription 140 instructions to operate unit 52A for dispensing prescription 140 according to a predetermined schedule, and to selectively re-program apparatus 50 with prescription instructions for a new prescription to be dispensed from unit 52A, according to the invention. Preferably, prescription information for prescription 140 of unit 52A of apparatus 50 is entered into record 241B via portal 241A, and transmitted electronically therefrom in response to storage 223. The login procedure can incorporate biometric, RFID, or other selected credenetials to enable access to record 241B via portal 241. Individual subscriber units 242 configured with application 243 can also access record 241B via portal 241A using a chosen and customary login procedure. The login procedure can be different for different users, for enabling certain authorized parties, such as doctors, pharmacists, and the like, to access change/update the information in record 241B for programming apparatus 50, and for enabling other authorized users, such as the patient, caregiver, spouse, etc., to access record 241B only for viewing.

According to the invention, the prescription instructions for prescription 140 include the number of pills in prescription, such as 10 pills, 20 pills, 25 pills, 30 pills, or other number of pills. Part of the prescription instructions programmed into storage 223 is to keep track of the number of pills 141 of prescription 140 dispensed. When the number of pills 141 dispensed is reaching the end of the prescription 140, such as when there is one, two, three, four, five, or other chosen number of pills 141 remaining in prescription, processor 221 is responsive and issues one or more notifications/alerts, such as email alerts or text message alerts, to one or more designated recipients, such as the patient, a designed caregiver, a spouse, the prescribing doctor, pharmacist, etc., to notify/alert the one or more intended recipients that prescription 140 in apparatus 50 is running low and in need of refilling to enable the recipient to follow up with the patient and/or the patient to take any necessary steps to renew the prescription. When a prescription is renewed, apparatus 50 is charged with a refill prescription as before and apparatus 50 is put to use as before for dispensing the given medication according to this disclosure.

Controller 220 automatically and independently operates each of units 52A-52E in this way as described in connection with unit 52A. When multiple pills of medicine are dispensed from two or more of units 52 at or approximately at the same time, sensor 238 senses medication arrival an dissues the second signal in response and the process continues as described above. Portal 241A described above can relate to one prescription of one of units 52A-52E, unit 52A in the above example, or to two or more prescriptions of two or more of units 52A-52E for the same patient. Accordingly, portal 241A can be unique to one prescription for one patient and a corresponding one of units 52A-52E, or to two or more prescriptions and a corresponding number of units 52A-52E for the same patient.

Apparatus 50 can be used with one prescription of a prescription drug, or a plurality of prescriptions of different prescription drugs, whether for the same patient or different patients. When apparatus 50 is used with one prescription of a prescription drug, processor 221 is programmed with instructions housed in storage 223 for operating a corresponding one of the units 52 charged with the chosen prescription drug. When apparatus 50 is used with two, three, four, or five prescriptions of different prescription drugs, processor 221 is programmed with instructions housed in storage 223 for operating each one of units 52 charged with the chosen prescription drug as described above. Furthermore, controller 220 can be programmed to activate light 233 to issue a first signal, such as the color blue, when there is no medicine in dispenser 80, a second different signal, such as the color green, when there is medicine in dispenser 80 as sensed by sensor 238, and a different third signal, such as the color red, when there is medicine in dispenser 80 as sensed by sensor 238 exceeding a predetermined period of time, such as five minutes, ten minutes, or other selected duration of time from when the medicine is deposited into dispenser 80.

When apparatus 50 houses medicines for multiple patients, processor 221 of controller 220 can be programmed with multiple patient profiles and a user interface, such as a touchscreen or the like, of apparatus 50 operatively connected to processor 221 can be accessed and used to select different patient profiles of apparatus 50. After a particular profile is selected, processor 221, preprogrammed with the multiple user profile information, will cause controller 220 to automatically activate apparatus 50 according to the chosen profile. In the alternative, the patient can select a dispense button on apparatus 50 that will cause processor 221 of controller 220 to automatically activate apparatus 50 to automatically issue on or more medicines to dispenser 80 in response.

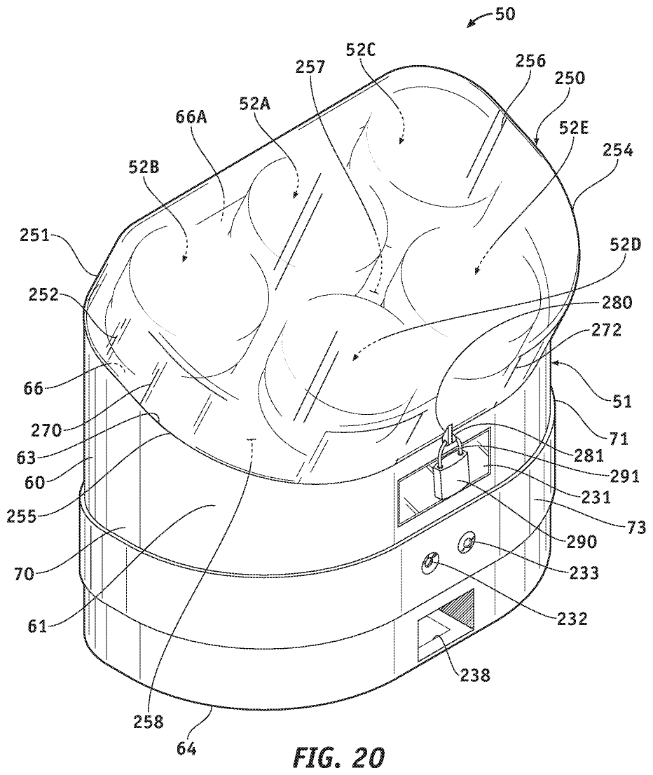

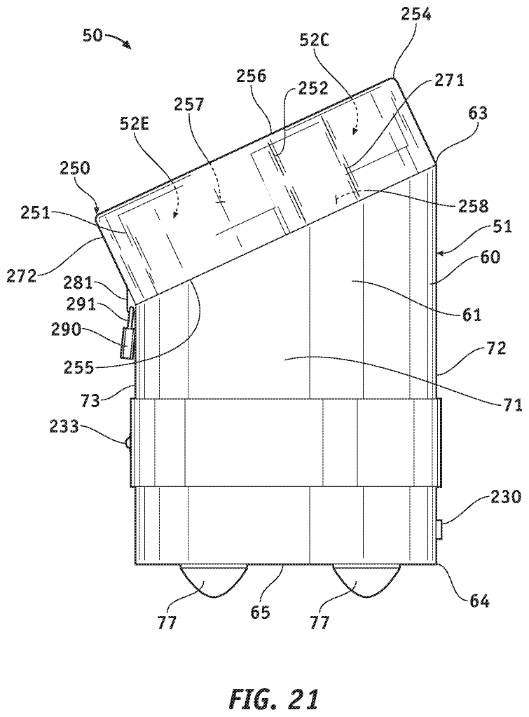

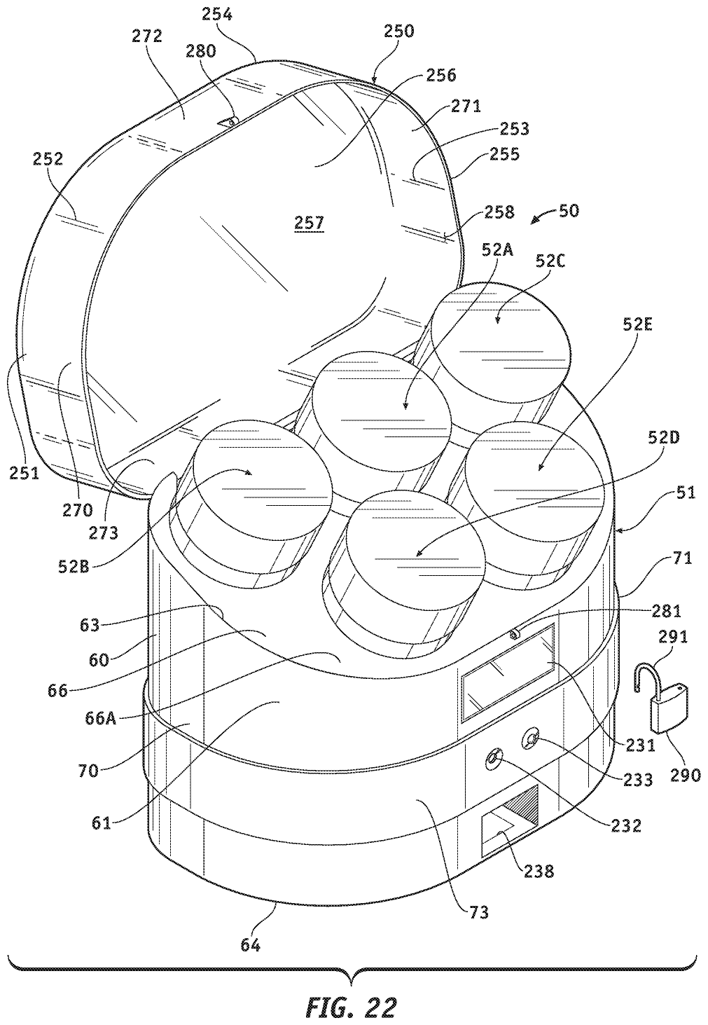

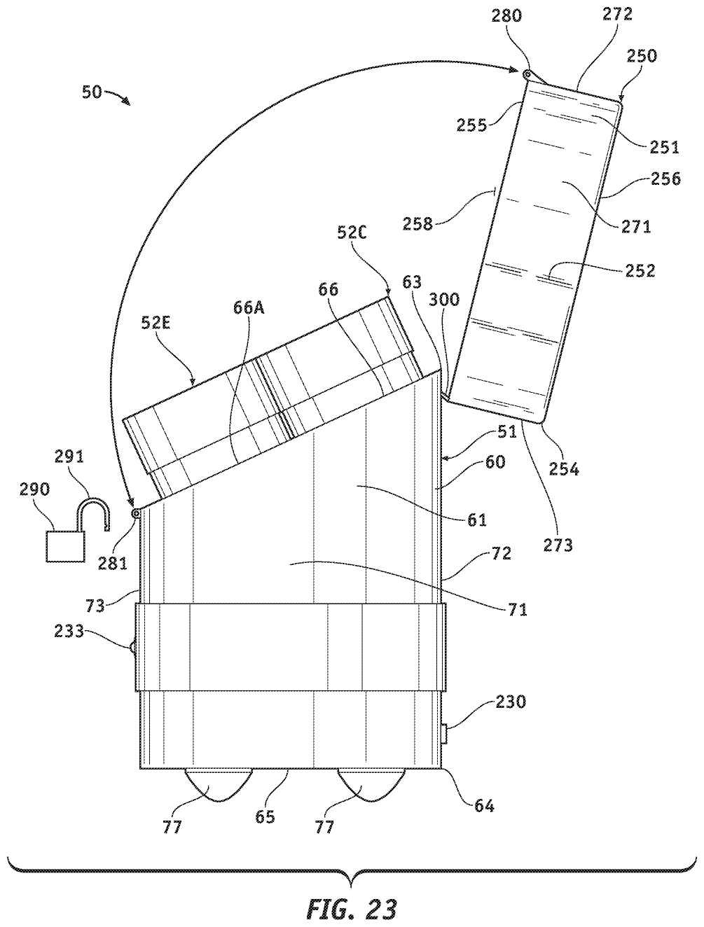

FIG. 20 is a view similar to that of FIG. 1 illustrating apparatus 50 as it would appear configured with a lid 250, which is shown closed and locked enclosing units 52 between top 66 of housing 51 and lid 250 for disabling unauthorized access to units 52. FIG. 21 is a side elevation view of the embodiment of FIG. 20, FIG. 22 is a view similar to that of FIG. 20 showing lid 250 unlocked and opened for enabling authorized access to unit 52, and FIG. 23 is a side elevation view of the embodiment of FIG. 22.

Referring to FIGS. 22 and 23 in relevant part, lid 250, which is fashioned integrally of transparent plastic in this example to enable units 52 to be seen therethrough when lid 250 is closed and locked in FIGS. 20 and 21, includes continuous sidewall 251 having outer surface 252, inner surface 253, upper edge 254, and lower edge 255. Horizontal top 256 is affixed to upper edge 254. Top 256 cooperates with inner surface 253 of sidewall 251 90 to form volume 257. Lower edge 255 encircles opening 258 to volume 257.

Continuous sidewall 251 includes opposed side walls 270 and 271 that extend between opposed front and back walls 272 and 273. Eye coupling 280 projects radially outward from outer surface 252 of front wall 272 proximate to lower edge 255 at an intermediate location between side walls 270 and 271, and a corresponding eye coupling 281 projects outward from outer surface 61 of front 73 of continuous sidewall 60 of housing 51 between sides 71 and 72 of housing 51.

Lid 250 is mounted rotatably to housing 51 for rotation with hinge 300 in FIG. 23 between a closed position in FIGS. 20 and 21 to enclose units 52 in volume 257 of lid 250 through opening 258 for disabling access to units 52, and an open position in FIGS. 22 and 23 away from and exposing units 52 for enabling access to units 52 for enabling units 52 to be selectively charged/filled with prescription drugs. More specifically, back wall 273 of lid 250 is mounted rotatably to back 72 of housing 51 proximate to top 66 for rotation with conventional hinge 300 between the closed position of lid 250 in FIGS. 20 and 21 and the open position of lid 250 in FIGS. 22 and 23. Units 52 are applied into volume 257 through opening 258 and are enclosed in volume 257 by lid 250 and lower edge 255 of lid 250 encircles units 52 and is in direct contact against upper surface 66A of top 66 proximate to upper edge 63 of continuous sidewall 60 surrounding units 52, when lid 250 is rotated to its closed position in FIGS. 20 and 21. Units 52 are withdrawn from volume 257 through opening 258 lid 250 is rotated upwardly to the back of apparatus 50 exposing units 52 and top 66 of housing 51, when lid 250 is rotated to from its closed position in FIGS. 20 and 21 to its open position in FIGS. 22 and 23. Eye couplings 280 and 281 are links that align when lid 250 is in its closed position, enabling shackle 291 of a detachable lock 290 hanging therefrom to be concurrently passed through eye couplings 280 and 281 and then secured to detachable lock 290 in FIG. 22 for securing and locking lid 250 in its closed position. Detachable lock 290 is a conventional key-operated padlock in this example, and can be a standard combination padlock or other detachable lock in alternate embodiments. Eye couplings 280 and 281 and detachable lock 290 define an embodiment of a lock assembly useful for locking lid 250 to housing 51 in the closed position of lid 250 for disabling unauthorized movement of lid 250 from its closed position to its open position while at the same time disabling unauthorized access to units 52. Other mechanical locking assemblies/mechanisms known to the skilled person can be used to lock lid 250 in its closed position. Lid 250 is especially useful when caps 101 of the various units 52 are not in the form of safety caps. Preferably, lid 250 is closed and locked by the pharmacist after having selectively charged/filled one or more of units 52 prescription medicine and before handing off the charged apparatus 50 to the given patient.

Those having regard for the art will readily appreciate that an exemplary portable medicine dispensing apparatus 50 is disclosed, which includes housing 51 supporting dispenser 80, controller 220, and separate medicine storing and dispensing units 52, each of units 52 when activated is for automatically depositing a pill of medicine therefrom into dispenser 80, and controller 220 for independently and automatically activating each of units 52 at pre-determined times. Each of units 52 includes container 100 including bottom 116, turntable 120 in container 100 atop bottom 116, turntable 120 mounted for rotation and includes single pill-receiving aperture 134, an opening through turntable 120, turntable 120 and bottom 116 are concurrently downwardly inclined at the same angle of inclination from upper side 118 of container 100 to lower side 119 of container 10, upper side 118 of container 100 being elevated relative to lower side 119 of container 100, bottom 116 includes single discharge opening 135 at upper side 118 of container 100, container 100 for receiving identically sized and shaped pills of medicine atop turntable 120 and collecting the pills by gravity at lower side 119 of container 100, pill-receiving aperture 134 sized and shaped corresponding to the size and the shape of each of the pills of medicine, motor 121 when activated automatically rotates turntable 120 from the loading position of pill-receiving aperture 134 at lower side 119 of container 100 to the unloading position of pill-receiving aperture 134 at upper side 118 of container 100 over and registered with discharge opening 135, for conveying a pill of medicine received in pill-receiving aperture 134 at lower side 119 of container 100 from lower side 119 of container 100 to discharge opening 135 for enabling the pill of medicine to pass through discharge opening 135 from pill-receiving aperture 134 from within container 100 to dispenser 80, and back to the loading position of pill-receiving aperture 134 at lower side 119 of container 100, and turntable 130 isolates container 100 from discharge opening 135 for disabling pills in container 100 atop turntable 120 from passing through discharge opening 135 from within container 100 to dispenser 80 when turntable 120 is not in the unloading position of pill-receiving aperture 134. Controller 220 is for independently and automatically activating each of motors 121 at pre-determined times. Pill-receiving apertures 134 of the respective units 52 are differently sized and shaped for corresponding units 52 to differently sized and shaped pills of medicine. Lid 250 is mounted to housing 51 for movement between a closed position for concurrently enclosing and disabling unauthorized access to units 52, and an open position for enabling authorized access to units 52. A lock assembly is for locking lid 250 to housing when lid 250 is in the closed position for disabling unauthorized movement of lid 250 from the closed position to the open position. A signal device is for issuing a notification/alarm/alert when activated, and controller 220 for activating the signal device proximate to each said predetermined time. The signal device is aural signal device 232, and the alert is an audible alert. In another embodiment, the signal device is visual signal device 231/234, and the alert is a visual alert. In yet another embodiment, the signal device is vibrator 311, and the alert is is a vibratory alert. Sensor 238 is for sensing a withdrawal of at least one pill of medicine from dispenser 80, and the signal device automatically deactivates when sensor 238 senses the withdrawal of at least one pill of medicine from dispenser 80. Controller 220 is for issuing a notification to one or more individual subscriber units 242 proximate to each said predetermined time, the notification being a reminder to take medication.

Apparatus 50 is portable, being easily carried anywhere by hand. In an exemplary embodiment, apparatus 50 is filled with medicine, defining an exemplary embodiment a filled apparatus 50, whether one of units 52 being filled with a prescription of pills of medicine, a selected plurality of units 52 being filled with different prescriptions of pills of medicine, or all of units 52 being filled with different prescriptions of pills of medicine, and controller 220 is preprogrammed with related one or more prescription instructions for execution by controller 220 for automatically, independently and selectively activating one of units 52, a plurality of units 52, or all of units 52 depending on the number of prescriptions apparatus 50 is filled with. Accordingly, apparatus 50 is useful filled with one prescription of pills of medicine using one of units 52 with controller 220 programmed with corresponding prescription instructions for automatically and independently activating the filled unit 52, apparatus 50 is useful filled with a plurality of different prescriptions of pills of medicine using a plurality of units 52 with controller 220 programmed with corresponding prescription instructions for automatically and independently activating the various filled units 52, and apparatus 50 is useful filled with different prescriptions of pills of medicine using all of units 52 with controller 220 programmed with corresponding prescription instructions for automatically and independently activating all of units 52, in which each of the filled conditions of apparatus 50 defines an exemplary embodiment. Apparatus 50 disclosed herein is formed with five units 52 having a maximum capacity of being filled with five different prescriptions of pills of medicine, and an apparatus 50 constructed and arranged in accordance with the principle of the invention can include less than five units 52 or more than five units 52 as desired.

The present invention is described above with reference to illustrative embodiments. However, those skilled in the art will recognize that changes and modifications may be made in the described embodiments without departing from the nature and scope of the present invention. For instance, the signal devices, display 231, speaker 232, and light 233, are carried by apparatus 50. In an alternate embodiment, these signal devices are formed with a remote device 310 capable of being carried about by the patient. In this embodiment, remote device 310 is a wearable, a battery-powered wearable in the form of a bracelet wearable on the wrist, configured with the previously-described signal devices 231, 232, and 233 described above. When sensor 238 generates the first signal or “arrival” signal and processor 221 automatically transmits the “dispensed” signal, transmitter/receiver 222, remotely coupled to signal devices 231, 232, and 233 of remote device 310, automatically issues a corresponding “dispensed” signal to remote device 310 activating signal devices 231, 232, and 233, which issue the corresponding alerts as described above. When sensor 238 generates the second or “withdrawal” signal and controller 220 processor 221 automatically transmits the resulting “withdraw” signal, transmitter/receiver 222 automatically issues a corresponding “withdraw” signal to remote device 30 deactivating signal devices 231, 232, and 233. In this embodiment, remote device 310 is also configured with an additional signal device, namely, a vibrator 311 that issues a vibratory alert when activated, which is useful for people that are visually and/or hearing impaired. Each patient that uses apparatus 50 can be provided a remote device 310. Any form of wearable or carriable device can be used as desired, such as a wearable designed to be clipped to a belt, a glove, an arm band, etc. Various further changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A portable medicine dispensing apparatus comprising a housing supporting a dispenser, a controller, and separate medicine storing and dispensing units, each of the units when activated is for automatically depositing a pill of medicine therefrom into the dispenser, and the controller for independently and automatically activating each of the units at pre-determined times.

2. The portable medicine dispensing apparatus according to claim 1, further comprising a lid mounted to the housing for movement between a closed position for concurrently enclosing and disabling unauthorized access to the units and to medication deposited therein, and an open position for enabling authorized access to the units.

3. The portable medicine dispensing apparatus according to claim 2, further comprising a lock assembly for locking the lid to the housing when the lid is in the closed position for disabling unauthorized movement of the lid from the closed position to the open position.

4. The portable medicine dispensing apparatus according to claim 1, further comprising a signal device for issuing an alert when activated, and the controller for activating the signal device proximate to each said predetermined time.

5. The portable medicine dispensing apparatus according to claim 4, wherein the signal device is an aural signal device, and the alert is an audible alert.

6. The portable medicine dispensing apparatus according to claim 4, wherein the signal device is a visual signal device, and the alert is a visual alert.

7. The portable medicine dispensing apparatus according to claim 4, wherein the signal device is a vibrator, and the alarm comprises a vibratory alert.

8. The portable medicine dispensing apparatus according to claim 4, further comprising a sensor for sensing a withdrawal of at least one pill of medicine from the dispenser; and the signal device automatically deactivates when the sensor senses the withdrawal of at least one pill of medicine from the dispenser.

9. The portable medicine dispensing apparatus according to claim 1, further comprising the controller for issuing a notification to an individual subscriber unit proximate to each said predetermined time, the notification comprising a reminder to take medication.

10. A portable medicine dispensing apparatus, comprising:
a housing supporting a dispenser, a controller, and separate medicine storing and dispensing units each comprising:
a container including a bottom;
a turntable in the container atop the bottom, the turntable mounted for rotation and includes a single pill-receiving aperture;
the turntable and the bottom are downwardly inclined concurrently from an upper side of the container to a lower side of the container, the upper side of the container being elevated relative to the lower side of the container;
the bottom includes a single discharge opening at the upper side of the container;
the container for receiving identically sized and shaped pills of medicine atop the turntable and collecting the pills by gravity at the lower side of the container;
the pill-receiving aperture sized and shaped corresponding to the size and the shape of each of the pills of medicine;
a motor when activated automatically rotates the turntable from a loading position of the pill-receiving aperture at the lower side of the container to an unloading position of the pill-receiving aperture at the upper side of the container over and registered with the discharge opening, for conveying a pill of medicine received in the pill-receiving aperture at the lower side of the container from the lower side of the container to the discharge opening for enabling the pill of medicine to pass through the discharge opening from the pill-receiving aperture from within the container to the dispenser, and back to the loading position of the pill-receiving aperture at the lower side of the container; and
the turntable isolates the container from the discharge opening for disabling pills in the container atop the turntable from passing through the discharge opening from within the container to the dispenser when the turntable is not in the unloading position of the pill-receiving aperture; and
the controller for independently and automatically activating each of the motors at pre-determined times.

11. The portable medicine dispensing apparatus according to claim 10, wherein the pill-receiving apertures of the respective units are differently sized and shaped for corresponding the units to differently sized and shaped pills of medicine.

12. The portable medicine dispensing apparatus according to claim 10, further comprising a lid mounted to the housing for movement between a closed position for concurrently enclosing and disabling unauthorized access to the units, and an open position for enabling authorized access to the units.

13. The portable medicine dispensing apparatus according to claim 12, further comprising a lock assembly for locking the lid to the housing when the lid is in the closed position for disabling unauthorized movement of the lid from the closed position to the open position.

14. The portable medicine dispensing apparatus according to claim 10, further comprising a signal device for issuing an alert when activated, and the controller for activating the signal device proximate to each said predetermined time.

15. The portable medicine dispensing apparatus according to claim 14, wherein the signal device is an aural signal device, and the alert is an audible alert.

16. The portable medicine dispensing apparatus according to claim 14, wherein the signal device is a visual signal device, and the alert is a visual alert.

17. The portable medicine dispensing apparatus according to claim 14, wherein the signal device is a vibrator, and the alarm comprises a vibratory alert.

18. The portable medicine dispensing apparatus according to claim 14, further comprising a sensor for sensing a withdrawal of at least one pill of medicine from the dispenser; and the signal device automatically deactivates when the sensor senses the withdrawal of at least one pill of medicine from the dispenser.

19. The portable medicine dispensing apparatus according to claim 10, further comprising the controller for issuing a notification to an individual subscriber unit proximate to each said predetermined time, the notification comprising a reminder to take medication.

20. A portable medicine dispensing apparatus, comprising:
a housing supporting a dispenser, a controller, and separate medicine storing and dispensing units each comprising:
a container including a bottom;
a turntable in the container atop the bottom, the turntable mounted for rotation and includes a single pill-receiving aperture;
the turntable and the bottom are downwardly inclined concurrently from an upper side of the container to a lower side of the container, the upper side of the container being elevated relative to the lower side of the container;
the bottom includes a single discharge opening at the upper side of the container to the dispenser;
the container pre-filled with a prescription of identically sized and shaped pills of medicine, the pills of medicine being enclosed in the container atop the turntable, and collected by gravity at the lower side of the container;
the pill-receiving aperture sized and shaped corresponding to the size and the shape of each of the pills of medicine;
a motor when activated automatically rotates the turntable from a loading position of the pill-receiving aperture at the lower side of the container to an unloading position of the pill-receiving aperture at the upper side of the container over and registered with the discharge opening, for conveying a pill of medicine received in the pill-receiving aperture at the lower side of the container from the lower side of the container to the discharge opening for enabling the pill of medicine to pass through the discharge opening from the pill-receiving aperture from within the container to the dispenser, and back to the loading position of the pill-receiving aperture at the lower side of the container; and
the turntable isolates the container from the discharge opening for disabling pills in the container atop the turntable from passing through the discharge opening from within the container to the dispenser when the turntable is not in the unloading position of the pill-receiving aperture;
the controller for independently and automatically activating each of the motors at pre-determined times;
the pills of medicine of the respective prescriptions are differently sized and shaped; and
the pill-receiving apertures of the respective units are differently sized and shaped corresponding the units to the differently sized and shaped pills of medicine of the respective prescriptions.

21. The portable medicine dispensing apparatus according to claim 20, further comprising, a lid mounted to the housing for movement between a closed position for concurrently enclosing and disabling unauthorized access to the units, and an open position for enabling authorized access to the units, the lid is in the closed position, and a lock assembly locking the lid to the housing in the closed position disabling unauthorized movement of the lid from the closed position to the open position.

22. The portable medicine dispensing apparatus according to claim 20, further comprising a signal device for issuing an alert when activated, and the controller for activating the signal device proximate to each said predetermined time.

23. The portable medicine dispensing apparatus according to claim 22, wherein the signal device is an aural signal device, and the alert is an audible alert.

24. The portable medicine dispensing apparatus according to claim 22, wherein the signal device is a visual signal device, and the alert is a visual alert.

25. The portable medicine dispensing apparatus according to claim 22, wherein the signal device is a vibrator, and the alarm comprises a vibratory alert.

26. The portable medicine dispensing apparatus according to claim 22, further comprising a sensor for sensing a withdrawal of at least one pill of medicine from the dispenser; and the signal device automatically deactivates when the sensor senses the withdrawal of at least one pill of medicine from the dispenser.

27. The portable medicine dispensing apparatus according to claim 20, further comprising the controller for issuing a notification to an individual subscriber unit proximate to each said predetermined time, the notification comprising a reminder to take medication.
